(19) United States
(12) Patent Application Publication
(10) Pub. No.: US 2013/0187951 A1
(43) Pub. Date: Jul. 25, 2013

(54) AUGMENTED REALITY APPARATUS AND METHOD

(71) Applicant: Hirokazu SUZUKI, Machida-shi (JP)

(72) Inventor: Hirokazu SUZUKI, Machida-shi (JP)

(73) Assignee: KABUSHIKI KAISHA TOSHIBA, Tokyo (JP)

(21) Appl. No.: 13/727,120

(22) Filed: Dec. 26, 2012

(30) Foreign Application Priority Data
Jan. 19, 2012 (JP) 2012-008881

(51) Int. Cl. G06T 19/00

(52) U.S. Cl. CPC G06T 19/006
USPC 345/633

(57) ABSTRACT

According to one embodiment, an augmented reality apparatus includes an estimation unit, a search unit, a first generation unit, a second generation unit and selection unit. The estimation unit estimates a main facility. The search unit searches for facilities to obtain target facilities. The first generation unit generates a first feature value according to each item of interest of the user. The second generation unit generates a second feature value for each target facility. The selection unit calculates a degree of association based on the first feature value and the second feature value to select data of a target facility having the degree of association not less than a first threshold as recommended facility data.

### CROSS-REFERENCE TO RELATED APPLICATIONS

This application is based upon and claims the benefit of priority from Japanese Patent Application No. 2012-008881, filed Jan. 19, 2012, the entire contents of which are incorporated herein by reference.

### FIELD

Embodiments described herein relate generally to an augmented reality apparatus and method.

### BACKGROUND

Conventional augmented reality (AR) involves superimposing information about bricks-and-mortar facilities, such as retail outlets, on real-time, real-world images in which those facilities appear. This information can take the form of opinions (for example, customer reviews and recommendations) about the facilities, added beforehand via a social networking service (SNS) or online community, and factual information about the facilities. However, in the conventional method, there is a problem that the information presented to a user includes items the user will not find personally useful. Thus, it is important to present only information relevant to the user's immediate needs.

To solve this problem, there is a method involving the use of a predefined table indicating the user's interests with respect to different genres, such as movies and books, that can be correlated with geographic location, time, and nature of facility to predict the user's behavior and so select and display relevant information at any given moment.

### BRIEF DESCRIPTION OF THE DRAWINGS

FIG. 1 is an exemplary block diagram showing an augmented reality apparatus.

FIG. 2 illustrates an example of table stored in the user profile database.

FIG. 3 illustrates an example of table indicating items of interest stored in the interest database.

FIG. 4 illustrates an example of table indicating feature keywords.

FIG. 5 illustrates selection examples of the main facility and target facility at the main facility estimation unit and the target facility search unit.

FIG. 6 is an exemplary flowchart showing the operation of the augmented reality apparatus.

FIG. 7 illustrates an example of the display of the conventional augmented reality apparatus.

FIG. 8 illustrates an example of the display of the augmented reality apparatus.

### DETAILED DESCRIPTION

To realize the aforementioned method, it is necessary to statistically acquire the user's interests and accurately predict the user's behavior. However, if the user acts outside the range of predicted behavior, or it is not possible to determine the user's location, suitable information cannot be provided to the user.

In general, according to one embodiment, an augmented reality apparatus includes an estimation unit, a search unit, a first storage, a second storage, a first generation unit, a second generation unit and a selection unit. The estimation unit is configured to estimate a main facility located at a center of an image captured by a camera used by a user from map data, based on location data of the user and a direction that a lens of the camera faces. The search unit is configured to search for one or more facilities existing within a first distance from the main facility and within an angle of view of the camera from the map data, to obtain the searched one or more facilities as one or more target facilities. The first storage is configured to store one or more first items of interest in which the user is interested. The second storage is configured to store the first items of interest associated with one or more first feature keywords, each of the first feature keywords being each of plurality of keywords representing a feature of the item of interest. The first generation unit is configured to generate a first feature value according to the first feature keywords. The second generation unit is configured to generate, for each target facility, a second feature value in accordance with second feature keywords, the second feature keywords being one or more keywords of the plurality of keywords representing a feature of a target facility. The selection unit is configured to select data relating to a target facility having a degree of association not less than a first threshold as recommended facility data, the degree of association indicating an association between the target facility and the user and being calculated based on the first feature value and the second feature value for each target facility.

In the following, the augmented reality apparatus and method according to the present embodiment will be described in details with reference to the drawings. In the embodiment described below, elements specified by the same reference number carry out the same operation, and a repetitive description of such elements will be omitted.

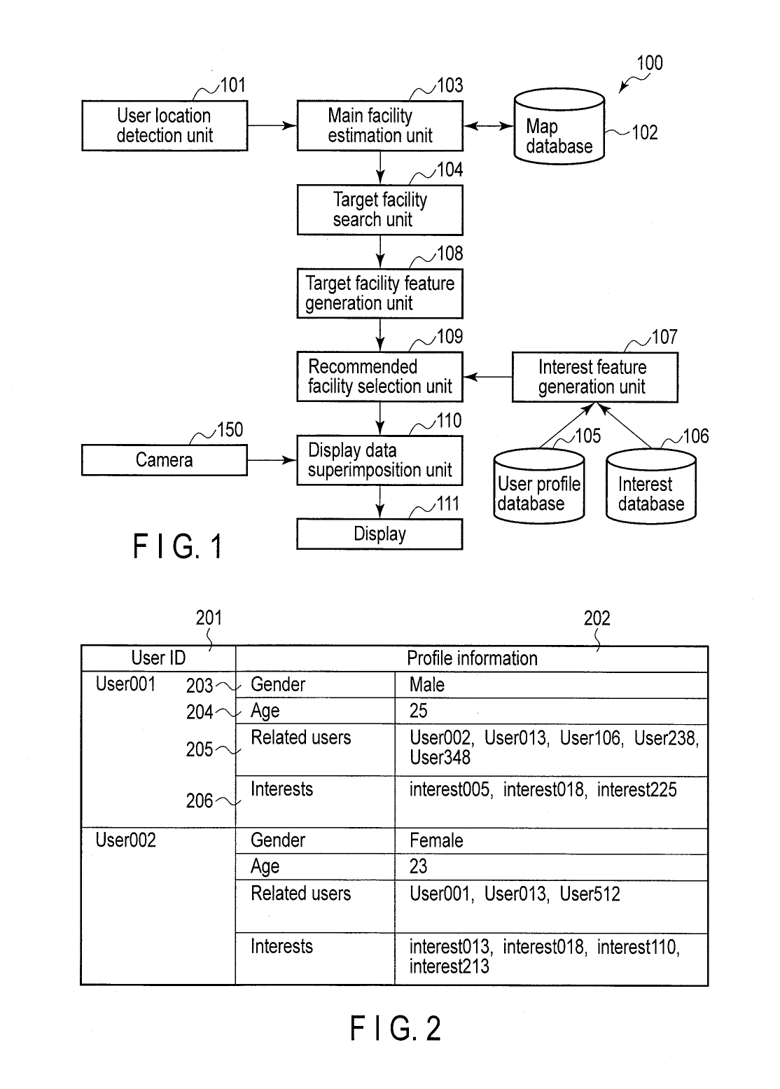

A utilization example of the augmented reality apparatus according to the present embodiment with reference to FIG. 1 follows.

The augmented reality apparatus 100 according to the present embodiment includes a user location detection unit 101, a map database 102, a main facility estimation unit 103, a target facility search unit 104, a user profile database 105, an interest database 106, an interest feature generation unit 107, a target facility feature generation unit 108, a recommended facility selection unit 109, a display data superimposition unit 110, and a display 111.

The user location detection unit 101 detects current location data of the user (the latitude and longitude) and the direction of a camera 150 used by the user. The location data can be detected by using the general global positioning system (GPS), for example. The direction of the camera 150 is the direction that the lens faces and can be detected by using the general hexaxial sensor, for example. The hexaxial sensor is a sensor including a triaxial geomagnetic sensor (electronic compass) and a triaxial acceleration sensor. Using the hexaxial sensor realizes detection of the direction of acceleration added to the camera 150 at the same time as detecting the direction of the camera 150 (four cardinal points; north, south, east and west, and elevation). The direction that the lens faces, elevation and the direction of acceleration are called orientation data.

The map database 102 stores map data regarding the latitude and longitude and facility data regarding facilities existing on the map, the map data and the facility data being associated with each other. Facilities include a shop, a restaurant, an accommodation such as a hotel and a public facility such as a city hall. The facility data includes the name, classification, telephone number and address of a facility as basic information, but may include any information about the facility. For example, for a restaurant, popular menu items may be included. The map database 102 may be stored in an external server.

The main facility estimation unit 103 receives location data of a user from the user location detection unit 101 and receives orientation data of the camera 150. The main facility estimation unit 103 extracts the user location and facilities around the user location from the map data stored in the map database 102, and estimates a facility located at the center of an image captured by the camera 150 (hereinafter, referred to as the “main facility”).

The target facility search unit 104 receives data of the estimated main facility from the main facility estimation unit 103, searches for facilities existing within a predetermined range relative to the main facility and within the angle of view of the camera 150, based on the estimated main facility from the map database 103. Then, the target facility search unit 104 determines the searched facilities as facilities to be recommended to a user (hereinafter, referred to as “target facilities”), and extracts facility data regarding the target facilities from the map database 103.

The user profile database 105 stores profile information of a user. The profile information includes a user ID, gender, age, and user's interests registered via an SNS, for example. The user profile database 105 will be explained with reference to FIG. 2 later.

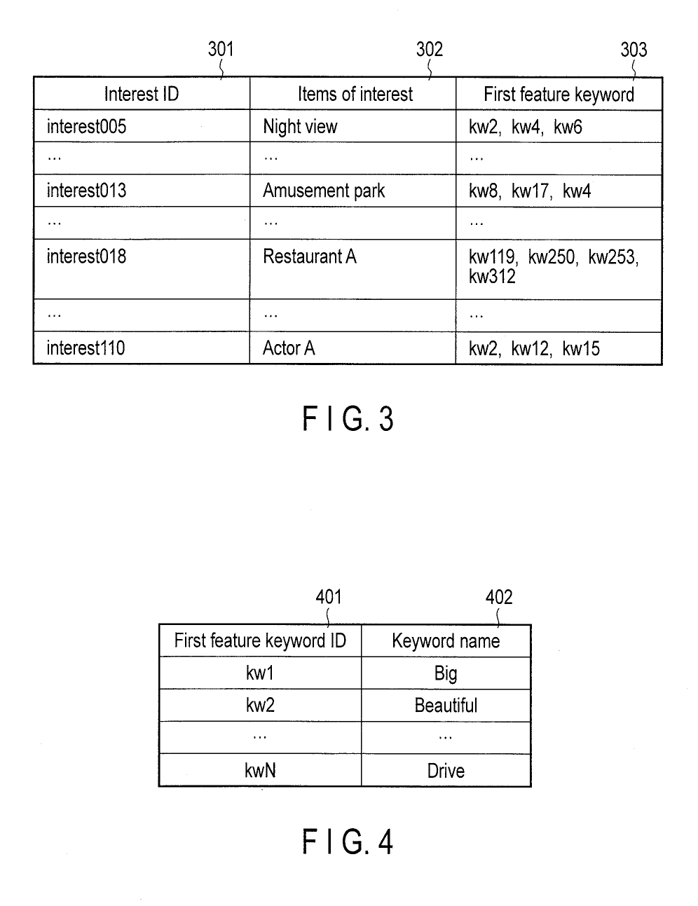

The interest database 106 stores one or more items of interest and one or more first feature keywords that are associated with each other. An item of interest is associated with one or more first feature keywords. The first feature keyword represents the feature of the corresponding item of interest. The interest database 106 will be explained with reference to FIGS. 3 and 4 later.

The interest feature generation unit 107 extracts the profile information from the user profile database 105 and extracts the first feature keywords from the interest database 106. The interest feature generation unit 107 obtains first values corresponding to the first feature keywords for each item of interest of the user included in the profile information, and generates a first feature value reflecting the features of the item of interest based on the first values.

The target facility feature generation unit 108 receives facility data of the target facilities from the target facility search unit 104, computes one or more second value for each target facility based on one or more second feature keywords and data related to the corresponding target facility, and generates a second feature value reflecting the features of each facility based on the second values. The second feature keywords represent the features of the corresponding target facility.

The recommended facility selection unit 109 receives the second feature values and the facility data of the target facilities from the target facility feature generation unit 108, and receives the first feature values from the interest feature generation unit 107. The recommended facility selection unit 109 computes the degree of association between a user and each target facility, and selects the facility data of a target facility whose degree of association is greater than or equal to a threshold value as recommended facility data. It is assumed that the facility data is received from the target facility feature generation unit 108; however, it is possible that the recommended facility selection unit 109 extracts facility data of the recommended facility from the map database 103 as recommended facility data after a recommended facility is selected.

The display data superimposition unit 110 receives image data from the camera 150 and receives the recommended facility data from the recommended facility selection unit 109. The display data superimposition unit 110 superimposes the recommended facility data on the image to produce a composite image.

The display 111 receives the composite image from the display data superimposition unit 110 and displays the composite image on a display.

The camera 150 may be a general CCD camera that is mounted, for example, on a mobile terminal, and is capable of capturing an image. The camera 150 captures images of facilities around a user to obtain image data.

Next, an example of table stored in the user profile database 105 will be explained with reference to FIG. 2.

In FIG. 2, the user profile database 105 stores user ID 201 and profile information 202 that are associated with each other. The user ID 201 is an ID with which a user can be uniquely identified. The profile information 202 includes a user's gender 203, age 204, related users 205 and interests 206. The related users 205 indicate users related to a given user, for example, users who know each other. In FIG. 2, user IDs of related users are associated with the user ID 201. The interests 206 include the matters that the user is interested in. In this embodiment, the interests 206 indicate IDs of items of interest (interest IDs described later).

Concretely, for user 001, the profile information 202 including the gender 203 which is male, the age 204 which is 25, the related users 205 which are user 002, user 013, user 106, user 238 and user 348, and the interests 206 which are interest 005, interest 018 and interest 225 is associated. The user profile database 105 contains profile records for each user.

An example of table regarding items of interest stored in the interest database 106 will be explained with reference to FIG. 3.

The interest database 106 stores interest IDs 301, items of interest 302 and first feature keyword 303 that are associated with each other.

The interest IDs 301 are stored as the interest 206 in the user profile database 105. The items of interest 302 indicate general names of items of interest, such as the names of singer, actor, movie, book, facility and activity. The first keyword 303 includes an ID of the first feature keyword (first feature keyword ID described later). The interest ID 301 and the item of interest 302 have one-to-one correspondence. In addition, one or more first feature keywords are associated with each interest ID 301. The same first feature keyword may be associated with multiple interest IDs 301.

Concretely, in FIG. 3, the interest ID 301, “interest005,” is associated with the item of interest 302 which is night view and the first feature keywords 303 which are kw2, kw4 and kw6.

An example of table regarding the first feature keyword will be explained with reference to FIG. 4.

In the table regarding the first feature keyword, a first feature keyword ID 401 and a keyword name 402 are associated with each other. Concretely, for the first feature keyword ID 401, “kw1,” the keyword name 402, “big,” is associated, and for the first feature keyword ID 401, “kw2,” the keyword name 402, “beautiful,” is associated. The keyword name 402 may include a classification, a proper noun or an adjective, but can be any characters or symbols that represent the feature of a facility or an item of interest. The table regarding the first feature keyword may be stored in the interest database 106, a different database, or an external database.

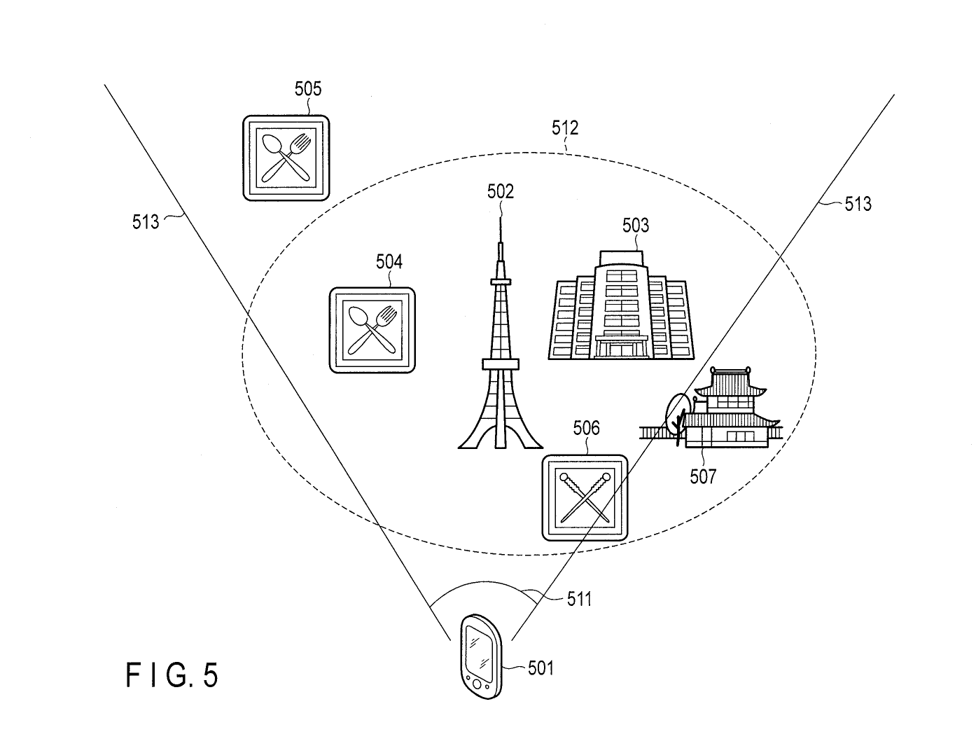

The facility extraction by the main facility estimation unit 103 and the target facility search unit 104 will be explained with reference to FIG. 5.

FIG. 5 shows an example image of target facilities captured by a mobile terminal 501. FIG. 5 shows the angle of view 511 of the camera 150 (not shown in the figure) mounted on the mobile terminal 501. In FIG. 5, a tower, a hotel, a Chinese restaurant and a Italian restaurant are shown. When the camera 150 captures the image, the main facility estimation unit 103 estimates a main facility in the captured image based on the user's current location, the orientation data and the angle of view 511 of the camera 150.

For example, the location data of the user and the orientation data of the camera 150 are mapped on the map data stored in the map database, and a facility that exists within the angle of view 511 of the camera 150 and is closest to the user among facilities on the center line of the angle of view 511 is estimated as a main facility. A facility existing on the center line of the angle of view 511, and within a predetermined distance from the user and having a size greater than or equal to a threshold may be evaluated as a main facility. In FIG. 5, since only a tower 502 exists within the angle of view 511 of the camera 150 and on the center line of the angle of view 511, the tower 502 is extracted as a main facility.

Next, the target facility search unit 104 extracts facilities existing within a predetermined range 512 from the main facility (a range enclosed with a dotted line in FIG. 5), and within the angle of view 511 as target facilities. In FIG. 5, a tower 502, a hotel 503, an Italian restaurant A 504 and a Chinese restaurant 506 exist within the predetermined range 512 from the tower 502 that is the main facility and within the angle of view 511, and these facilities are extracted as target facilities.

In this embodiment, if a facility exists on a periphery 513 of the angle of view 511, the facility whose portion inside the periphery 513 is greater than or equal to a threshold (in this case, if half of the facility is inside the periphery 513) is considered as a facility existing within the angle of view. In FIG. 5, a part of the Chinese restaurant 506 exists outside the angle of view 511, but exists within the predetermined range 512, and whose part greater than or equal to the threshold is within the angle of view. Accordingly, the Chinese restaurant 506 is extracted as a target facility. On the other hand, a temple 507 exists within the predetermined range 512, but whose part existing within the angle of view 511 is less than the threshold. Accordingly, the temple 507 is not extracted as a target facility. An Italian restaurant B 505 that exists outside the predetermined range 512 is not extracted as a target facility.

For the AR assumed in this embodiment, there is no need to present data of facilities existing in directions other than the direction of the camera (the sides or back of the user), or to present names of facilities far from the user. This is because data of facilities can be obtained if the user directs the camera. Thus, data of facilities in directions other than the direction of the camera is unnecessary for this system.

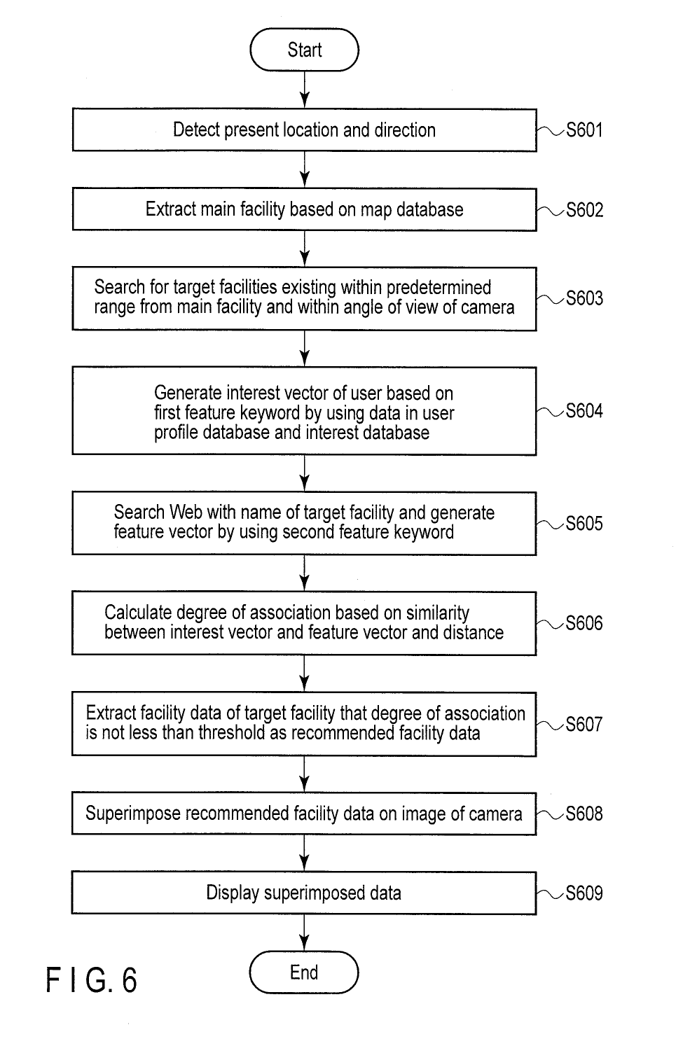

The operation of augmented reality apparatus 100 according to the present embodiment will be explained with reference to the flowchart of FIG. 6.

In the following, it is assumed that an interest vector is used as the first feature value. The interest vector has a component indicating whether or not each of one or more first feature keywords expresses a certain item of interest. In addition, it is assumed that a feature vector is used as the second feature value. The feature vector has a component indicating whether each of one or more second feature keywords expresses a certain target facility. Any index reflecting the features of an item of interest or a facility such as a value of a function may be used as the first or second feature value instead of a vector.

In step S601, the user location detection unit 101 detects the present location of the user and the direction of the camera 150 and obtains location data and orientation data.

In step S602, the main facility estimation unit 103 estimates a main facility based on the map database 102.

In step S603, the target facility search unit 104 searches for target facilities existing within a predetermined range relative to the main facility and within the angle of view of the camera, based on the estimated main facility.

In step S604, the interest feature generation unit 107 generates an interest vector of the user based on the user profile database 105 and the interest database 106.

The feature vector for item of interest I is represented by Ī, where whether or not the one or more first feature keywords associated with the item of interest I exist is shown in binary. The vector for item of interest I is given by

$$\overline{I} = [ \begin{matrix}{i}_{1} \\ ⋮ \\ {i}_{N}\end{matrix} ] \{ \begin{matrix}{i}_{k} = 1 & if {kw}_{k} exists \\ {i}_{k} = 0 & otherwise ,\end{matrix} \qquad ( 1 )$$

where N is the total number of first feature keywords, kwₖ is the k^{th} first feature keyword. The first value corresponding to each first feature keyword for items of interest is obtained in this way.

Since the user profile database 105 can register multiple items of interest, it is desirable to obtain vectors for all the items of interest of the user. Accordingly, the user's interests can be expressed.

u̅ₒ̅ represents an interest vector unique to a user (hereinafter, referred to as a “unique interest vector”), and can be expressed as a linear sum of feature vectors of each item of interest. If a set of the user's items of interest {Iⱼ}(1≦j≦m, j and m are natural numbers), the unique interest vector is given by

u̅ₒ̅=Σⱼ₌₁^{m}aⱼ· I̅ⱼ̅, (2)

where aⱼ is a weighting factor. If a weighting factor is set to be greater in line with the user's interests, a different unique interest vector can be generated for each user even if multiple users select the same item of interest.

The interest vectors for related users can be computed in the same way as for computing the unique interest vector.

u̅ᵣ̅ represents an interest vector of a related user. It is assumed that a user has multiple related users. The linear sum of interest vectors of each related user is given by

u̅_̅{̅R̅}̅=Σₛ₌₁ⁿbₛ· u̅ᵣ̅ₛ̅, (3)

where bₛ is a weighting factor to be added to the interest vector for each related user, and n is the number of related users. In the following, the linear sum of interest vectors of each related user is called a total related user interest vector.

If a weighting factor for a related user is set to be higher as the relationship between the user and the related user is closer, information that the user may be interested in can be extracted. If a weighting factor for a related user is set to be lower or zero as the relationship with the user is further apart, information of related users whose relation with the user is not close is not presented to the user. Taking the interest vectors of related users into consideration realizes acquisition of information that the related users have in addition to information that the user initially is interested in.

The interest feature generation unit 107 calculates the sum of the unique interest vector and the total related user interest vector to obtain a conclusive user's interest vector. The sum of the unique interest vector and the total related user interest vector is given by

ū=ūₒ+ū_{R}. (4)

In step S605, the target facility feature generation unit 108 performs a web search with the name of a target facility as a search keyword, and generates a feature vector for each target facility. Concretely, the target facility feature generation unit 108 searches for a keyword, examines whether or not a second feature keyword appears within a predetermined distance from the keyword within best-matching web pages, and generates a feature vector for each target facility based on the presence or absence of the second feature keyword.

For example, it is assumed that the name of a target facility, “xx amusement park,” is entered as a keyword for web searching, and a sentence, “xx amusement park illuminated from evening to night is beautiful,” appears best-matching web pages. In this case, the target facility feature generation unit 108 determines that a second feature keyword, “beautiful,” exists around the search keyword, “xx amusement park,” (in this case, the second feature keyword appears seven words after the search keyword). The target facility feature generation unit 108 determines whether or not a second feature keyword appears on the web pages as a word expressing the feature of a target facility. The target facility feature generation unit 108 repeats this process for all second feature keywords to compute vectors of second feature keywords for each target facility.

The second feature keywords are the same as the first feature keywords in the interest database 106. The vector of the second feature keywords for a target facility is given by

$$\overline{w} = [ \begin{matrix}{i}_{1} \\ ⋮ \\ {i}_{N}\end{matrix} ] \{ \begin{matrix}{i}_{k} = 1 & if {kw}_{k} exists \\ {i}_{k} = 0 & otherwise .\end{matrix} \qquad ( 5 )$$

As stated above, the second values of the second feature keywords for a target facility is obtained. The feature vector of a target facility when using q best-matching web pages (q is a natural number) for a search keyword is given by

v̅=Σₚ₌₁^{q}cₚ· w̅ₚ̅, (6)

where cₚ is a weighting factor. For example, weighting factors may be set to be higher in line with the ranking of web pages. The vector of second feature keywords obtained by equation (5) may be included in the facility data stored in the map database 102. It may be possible that a correspondence table of facility names and second feature keywords is prepared beforehand, and the target facility feature generation unit 108 extracts second feature keywords from the correspondence table when performing a web search, detects whether or not the second feature keywords appear, and dynamically generates the vector of second feature keywords.

In step S606, the recommended facility selection unit 109 calculates the degree of association Rel between a user and each target facility based on the similarity between the user's interest vector and the feature vector of the corresponding target facility, and the distance d between the main facility and the corresponding target facility. The degree of association is given by

$$Rel ( \overline{u} , \overline{v ,} \overline{d} ) = \frac{\overline{u} \cdot \overline{v}}{\vert \overline{u} \vert \vert \overline{v} \vert} \cdot {e}^{- τ d} , \qquad ( 7 )$$

where τ is an attenuation coefficient relative to the distance. The first part of the right side of equation (7) represents the cosine similarity between the user's interest vector and the feature vector of a target facility, and the last part of the right side of equation (7) is a function indicating that the value of Rel is attenuated as the target facility gets further from the main facility. By using this equation, a target facility whose feature is closely related to the user's interests and whose distance from the main facility (or the user) is close is prioritized.

In step S607, the recommended facility selection unit 109 selects facility data of a target facility whose degree of association is greater than or equal to a threshold as recommended facility data.

In step S608, the display data superimposition unit 110 superimposes the recommended facility data on image data of the camera. For a target facility whose degree of association is large, the facility data of the target facility may be highlighted with a larger font or with a different color so that the user can easily realize the data. On the other hand, for a target facility whose degree of association is small, the facility data may be indicated with a smaller font or a different color.

In step S609, the display 111 displays superimposed data on a screen.

The operation of the augmented reality apparatus 100 according to the present embodiment is completed by the above process. To present real-time data, the operation may be repeated in a short period (for example, 1 millisecond), or the operation may be stopped when the acceleration sensor detects the movement of camera and resumed when the movement of camera is stopped.

In step S606, the other users' evaluation scores may be reflected to the calculation of the degree of association, and the degree of association of a target facility may be set to be higher as the evaluation of the target facility becomes higher. For example, in equation (7), a weighting factor is multiplied to the right side. In this case, the facility whose evaluation is higher is weighted to be higher. By so doing, it is possible to select recommended facility data with high reliability.

The method for selecting related users at the interest feature generation unit 107 will be explained. If the number of related users is large, the enormous amount of calculation is necessary for calculating interest vectors for all related users. In this case, it is desirable to limit the number of related users to be used for the calculation.

One of the methods for selecting related users is to use the distance on a social graph. The social graph is a graph in which the relationships between a user and related users and between the related users are indicated with connected lines. Generally, the users whose distance is small on the social graph are considered to have a close relationship, and the users whose distance is large are considered to have a distant relationship.

The weighting factor in consideration of the distance on the social graph when calculating the total interest vector of related users is given by

$${b}_{s} = \frac{1}{distance between related users on soc i al graph} . \qquad ( 8 )$$

If the distance on the social graph is greater than or equal to a predetermined amount, bₛ may be zero. That is, the interest feature generation unit 107 calculates the total interest vector of related users by using only related users whose distance from the user is within the predetermined value on the social graph to select only related users who have close relationships with the user.

The second method for selecting related users is to weight related users who satisfy a predetermined condition to be high (or low). For example, if related users whose age is close to (or far from) that of the user or whose gender is the same as (or different from) that of the user are weighted to be high, the interest vectors of the related users can be generated in ways that put more importance on these weighted users. If certain related users are weighted to be low or zero, influence of these users to the user's interests can be lowered, or these users can be ignored.

The third method for selection is to consider the users who have evaluated a target facility. In the above methods, the related users are derived from the user's data. On the other hand, in this method, a certain user group including users who do not even have direct or indirect relationship to the user is selected as related users. The certain user group may include users who have evaluated a target facility, for example, a target restaurant, by star grading, point grading or reviewing. In this case, the weighting factor bₛ in equation (8) may be a fixed value or may be set to be higher (or lower) for related users who satisfy a predetermined condition.

The above user group may be extracted via an SNS or based on information within a website on which customers' reviews are compiled. According to this method, a certain interest vector with a specific condition such as a man in his thirties who marked a target facility with a grade of three or more stars can be used. This realizes effective extraction of facility data for which the user's interest is high.

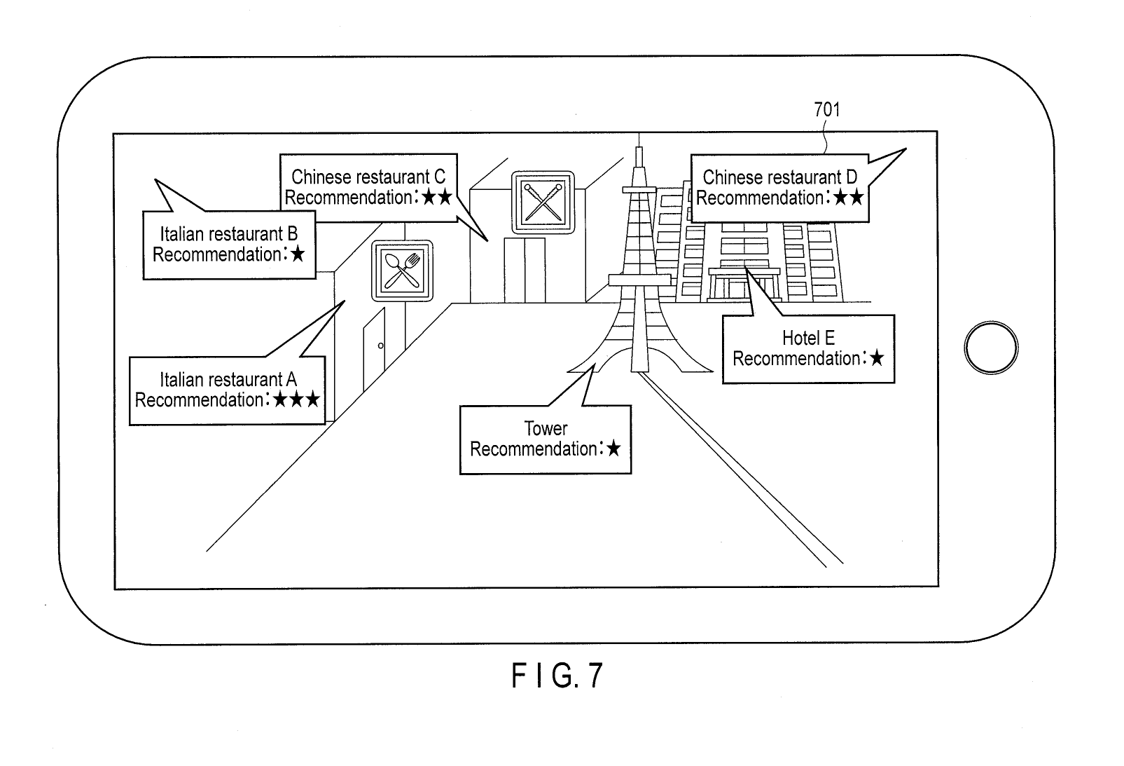

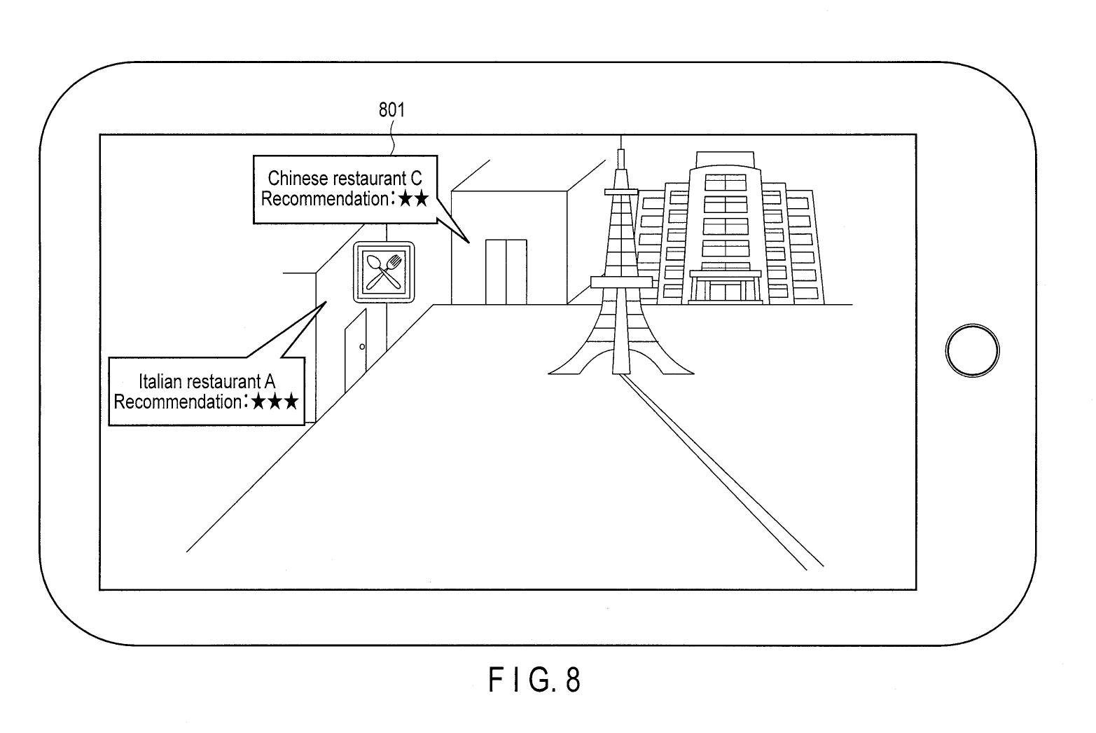

An example of display at the display 111 will be explained with reference to FIGS. 7 and 8.

FIG. 7 shows an example of displaying facility data in the conventional AR apparatus, and FIG. 8 shows an example of display of the augmented reality apparatus 100 according to the present embodiment. FIGS. 7 and 8 show an image in which facility data is superimposed on image of a camera displayed on the display 111.

As shown in FIG. 7, in the display of the conventional AR apparatus, facility data 701 on all facilities existing within the angle of view of the camera 150 is displayed, and it is difficult for a user to find information on facilities that the user is really interested in.

On the other hand, in FIG. 8, only recommended facility data 801 on recommended facilities whose degrees of association with the user are high is displayed. Accordingly, the user can quickly and effectively realize required information.

With the AR apparatus according to the present embodiment, since recommended facilities are selected in accordance with the degree of association with a user, information on facilities can be effectively presented to the user. In addition, information is selected based not only on the user's interests, but also on recommendation from the user's acquaintances or interests of related users. Accordingly, a user can obtain not only information that the user is initially interested in, but also unexpected information from the related users. This increases a possibility that a user will find new information or experience an unexpected event with the AR apparatus.

In addition, the configuration of the AR apparatus according to the present embodiment may be implemented by a terminal and a server. For example, the terminal may include the user location detection unit 101, display data superimposition unit 110, the display 111 and the camera 150, and the server may include the main facility estimation unit 103, the target facility search unit 104, the target facility feature generation unit 108, the user profile database 105, the interest database 106, the interest feature generation unit 107 and the recommended facility selection unit 109. In this configuration, the server performs the large amount of calculation, and the load of the terminal can be reduced. This simplifies the configuration of terminal.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An augmented reality apparatus, comprising:
an estimation unit configured to estimate a main facility located at a center of an image captured by a camera used by a user from map data, based on location data of the user and a direction that a lens of the camera faces;
a search unit configured to search for one or more facilities existing within a first distance from the main facility and within an angle of view of the camera from the map data, to obtain the searched one or more facilities as one or more target facilities;
a first storage configured to store one or more first items of interest in which the user is interested;
a second storage configured to store the first items of interest associated with one or more first feature keywords, each of the first feature keywords being each of a plurality of keywords representing a feature of the item of interest;
a first generation unit configured to generate a first feature value according to the first feature keywords;
a second generation unit configured to generate, for each target facility, a second feature value in accordance with second feature keywords, the second feature keywords being one or more keywords of the plurality of keywords representing a feature of a target facility; and
a selection unit configured to select data relating to a target facility having a degree of association not less than a first threshold as recommended facility data, the degree of association indicating an association between the target facility and the user and being calculated based on the first feature value and the second feature value for each target facility.

2. The apparatus according to claim 1, wherein the first storage further stores one or more second items of interest in which related users are interested, the related users having a relationship with the user and being associated with the user, and
wherein the first generation unit generates the first feature value based on the first items of interest and the second items of interest.

3. The apparatus according to claim 1, wherein the first generation unit generates a first vector corresponding to each of one or more first items of interest and having one or more first values relative to the corresponding first feature keywords as components, each first values being determined based on a corresponding first feature keyword and an item of interest,
generates a second vector for each of one or more second items of interest of the one or more related users, generates a third vector by multiplying a first weighting value determined in accordance with a relationship between the user and each related user by the corresponding second vector, and adds the first vector and the third vector to generate the first feature value.

4. The apparatus according to claim 1, wherein the second generation unit searches for contents including the data relating to the target facility by using a name of the target facility as a search keyword, generates one or more second values based on frequency of appearance of each of the second feature keywords within the contents obtained by the search, generates a fourth vector having the second values as components for each of the contents, and sums each of third values obtained by multiplying a second weighting value by fourth vectors to generate the second feature value, the second values determined based on corresponding second feature keywords and the data relating to the target facility, and being associated with a target facility.

5. The apparatus according to claim 1, wherein the selection unit calculates the degree of association based at least on a similarity between the first feature value and the second feature value and a third weighting value, the third weighting value being set to be smaller as a distance between the main facility and the target facility becomes larger.

6. The apparatus according to claim 5, wherein the selection unit weights the degree of association of a target facility to be higher as an evaluation of the target facility becomes higher.

7. The apparatus according to claim 3, wherein the first generation unit sets the first weighting value to be greater as the degree of association between the user and the related user becomes greater.

8. The apparatus according to claim 3, wherein the first generation unit sets the first weighting value to be smaller as the degree of association between the user and the related user is lower.

9. The apparatus according to claim 1, wherein the first generation unit uses, as the related users, first users whose distance to the user is not more than a second threshold on a social graph for generation of the first feature value, the social graph indicating relationships between the user and the related users.

10. An augmented reality apparatus, comprising:
an estimation unit configured to estimate a main facility located at a center of an image captured by a camera used by a user from map data, based on location data of the user and a direction that a lens of the camera faces;
a search unit configured to search for one or more facilities existing within a first distance from the main facility and within an angle of view of the camera from the map data, to obtain the searched one or more facilities as one or more target facilities;
a first storage configured to store one or more first items of interest in which the user is interested;
a second storage configured to store the first items of interest associated with one or more first feature keywords, each of the first feature keywords being each of a plurality of keywords representing a feature of the item of interest;
a first generation unit configured to generate a first feature value according to the first feature keywords corresponding to the items of interest of the user and related users who have evaluated the one or more target facilities;
a second generation unit configured to generate, for each target facility, a second feature value in accordance with second feature keywords, the second feature keywords being one or more keywords of the plurality of keywords representing a feature of a target facility; and
a selection unit configured to select data relating to a target facility having a degree of association not less than a first threshold as recommended facility data, the degree of association indicating an association between the target facility and the user and being calculated based on the first feature value and the second feature value for each target facility.

11. The apparatus according to claim 10, wherein the first generation unit generates the first feature value by using only first feature keywords of related users who satisfy a predetermined condition.

12. The augmented according to claim 1, further comprising:
a superimposition unit configured to superimpose the recommended facility data on image data of the camera; and
a display configured to display the superimposed image data.

13. An augmented reality method, comprising:
estimating a main facility located at a center of an image captured by a camera used by a user from map data, based on location data of the user and a direction that a lens of the camera faces;
searching for one or more facilities existing within a first distance from the main facility and within an angle of view of the camera from the map data, to obtain the searched one or more facilities as one or more target facilities;
storing, in a first storage, one or more first items of interest in which the user is interested;
storing, in a second storage, the first items of interest associated with one or more first feature keywords, each of the first feature keywords being each of a plurality of keywords representing a feature of the item of interest;
generating a first feature value according to the first feature keywords;
generating, for each target facility, a second feature value in accordance with second feature keywords, the second feature keywords being one or more keywords of the plurality of keywords representing a feature of a target facility; and
selecting data relating to a target facility having a degree of association not less than a first threshold as recommended facility data, the degree of association indicating an association between the target facility and the user and being calculated based on the first feature value and the second feature value for each target facility.

14. The method according to claim 13, wherein the storing the one or more second items of interest in which related users are interested, the related users having a relationship with the user and being associated with the user, and
the generating the first feature value generates the first feature value based on the first items of interest and the second items of interest.

15. The method according to claim 13, wherein the generating the first feature value generates a first vector corresponding to each of one or more first items of interest and having one or more first values relative to the corresponding first feature keywords as components, each first values being determined based on a corresponding first feature keyword and an item of interest,
generates a second vector for each of one or more second items of interest of the one or more related users, generates a third vector by multiplying a first weighting value determined in accordance with a relationship between the user and each related user by the corresponding second vector, and adds the first vector and the third vector to generate the first feature value.

16. The method according to claim 13, wherein the generating the second feature value searches for contents including the data relating to the target facility by using a name of the target facility as a search keyword, generates one or more second values based on frequency of appearance of each of the second feature keywords within the contents obtained by the search, generates a fourth vector having the second values as components for each of the contents, and sums each of third values obtained by multiplying a second weighting value by fourth vectors to generate the second feature value, the second values determined based on corresponding second feature keywords and the data relating to the target facility, and being associated with a target facility.

17. The method according to claim 13, wherein the calculating the degree of association calculates the degree of association based at least on a similarity between the first feature value and the second feature value and a third weighting value, the third weighting value being set to be smaller as a distance between the main facility and the target facility becomes larger.

18. The method according to claim 17, wherein the calculating the degree of association weights the degree of association of a target facility to be higher as an evaluation of the target facility becomes higher.

19. The method according to claim 15, wherein the generating the first feature value sets the first weighting value to be greater as the degree of association between the user and the related user becomes greater.

20. The method according to claim 15, wherein the generating the first feature value sets the first weighting value to be smaller as the degree of association between the user and the related user is lower.
